(19) United States
(12) Patent Application Publication
(10) Pub. No.: US 2008/0101810 A1
(43) Pub. Date: May 1, 2008

(54) IMAGE FORMING APPARATUS, FIXING DEVICE, LIGHT BLOCKING DEVICE, LIGHT BLOCKING MEMBER AND HOLDING DEVICE FOR IMAGE CARRIER

(75) Inventors: Shigeru Morimoto, Saitama (JP); Katsumi Harumoto, Saitama (JP); Mikio Saiki, Saitama (JP); Hiroko Furukata, Saitama (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/858,926

(22) Filed: Sep. 21, 2007

(30) Foreign Application Priority Data
Oct. 27, 2006 (JP) 2006-292568

(51) Int. Cl. G03B 27/00

(52) U.S. Cl. 399/51

(57) ABSTRACT

An image forming apparatus includes: an image carrier; a fixing device disposed above the image carrier and fixing a transferred image on a recording medium to the recording medium, the transferred image being transferred from the image carrier; and a light blocking member disposed on the fixing device and blocking at least part of light reaching the image carrier.

### CROSS-REFERENCE TO RELATED APPLICATION

This application is based on and claims priority under 35 USC §119 from Japanese Patent Application No. 2006-292568 filed Oct. 27, 2006.

### BACKGROUND

(i) Technical Field

The present invention relates to an image forming apparatus, a fixing device, a light blocking device, a light blocking member, and a holding device for an image carrier.

(ii) Related Art

An image forming apparatus is known in which a to-be-transferred image is formed on an image carrier on which a latent image is optically formed, and then transferred to a recording medium such as a sheet to perform printing. In such an image forming apparatus, in order to remove paper jamming occurring in the apparatus, and replace a so-called process cartridge having the image carrier and the like, a cover member is temporarily opened.

In an image forming apparatus which performs printing, an image carrier is exposed to light in the case of removal of paper jamming, replacement of a process cartridge, etc. In order to prevent light from reaching the image carrier, an image forming apparatus is sometimes provided with a door mechanism which is swingingly movable along the circumference of the image carrier.

### SUMMARY

According to an aspect of the invention, there is provided an image forming apparatus comprising:

an image carrier;

a fixing device disposed above the image carrier and fixing a transferred image on a recording medium to the recording medium, the transferred image being transferred from the image carrier; and

a light blocking member disposed on the fixing device and blocking at least part of light reaching the image carrier.

### BRIEF DESCRIPTION OF THE DRAWINGS

Embodiments of the present invention will be described in detail based on the following figures, wherein:

FIG. 1 is a side view of an image forming apparatus of a first exemplary embodiment;

FIG. 2 is a view showing a case where a process cartridge in the first embodiment is detached;

FIG. 3 is a perspective view of the image forming apparatus of the first embodiment;

FIG. 4 is a side view of a state where a cover member is opened;

FIG. 5 is a side view of a state where the cover member is slightly opened;

FIG. 6 is a side view of a state where the cover member is closed;

FIG. 7 is a side view of a state where the cover member is opened;

FIG. 8 is a side view of a state where the cover member is slightly opened;

FIG. 9 is a side view of a state where the cover member is closed;

FIG. 10 is a view showing a third exemplary embodiment;

FIG. 11 is a side view of a process cartridge in which a visor is disposed above a photoconductor drum;

FIG. 12 is a view showing a fifth exemplary embodiment;

FIG. 13 is a view showing a sixth exemplary embodiment; and

FIG. 14 is a view showing a seventh exemplary embodiment.

### DETAILED DESCRIPTION

Hereinafter, an example of an image forming apparatus to which the invention is applied will be described with reference to the accompanying drawings. Although the following description of the example includes words such as “photoconductor drum (image carrier) 30”, these words do not restrict the scope of the invention, but facilitate understanding of correspondence relationships between the invention and an embodiment which will be described as an example. With respect to the exemplified words of “photoconductor drum (image carrier) 30”, therefore, the image carrier is not restricted to a photoconductor drum, and may have any form as far as it can carry an image.

### (1) First Embodiment

### (Configuration)

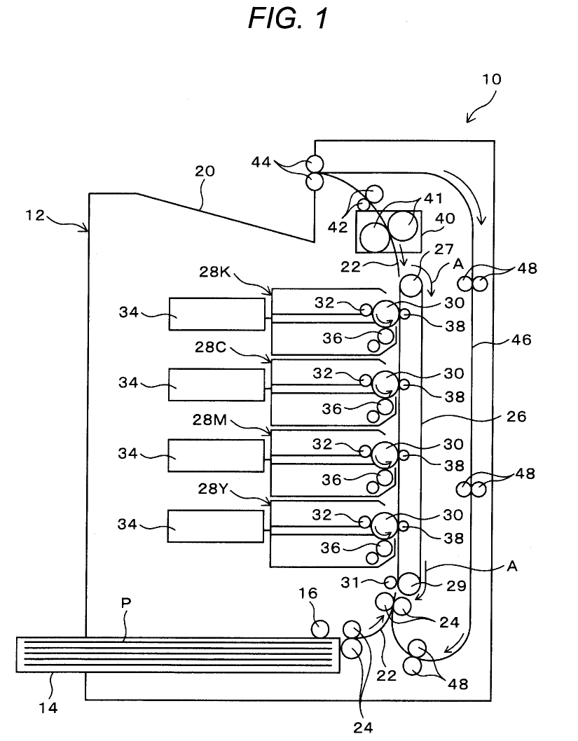

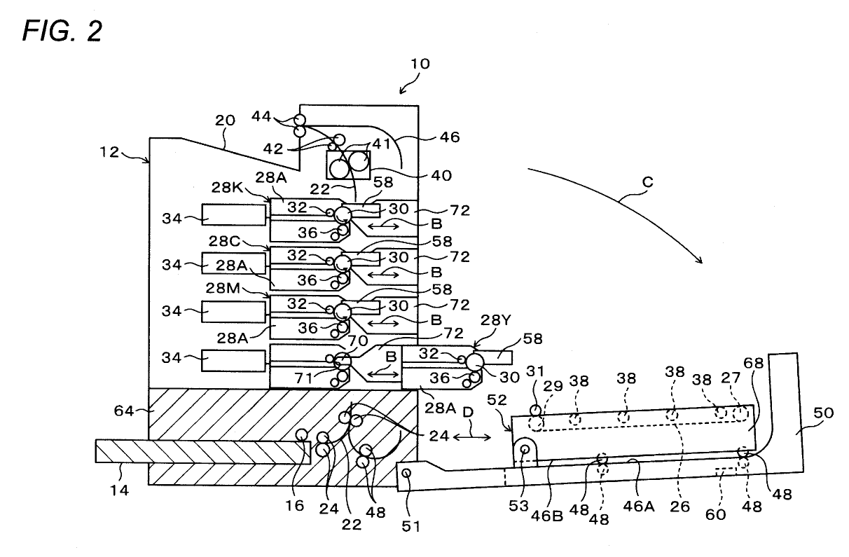

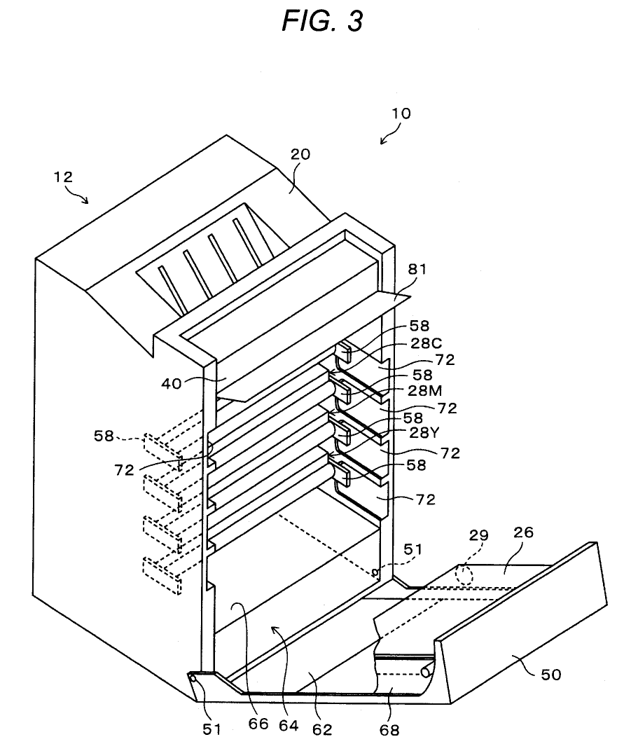

First, the whole configuration of the image forming apparatus 10 to which the invention is applied will be described. FIG. 1 is a side view of an image forming apparatus of a first exemplary embodiment, FIG. 2 is a view showing the case where a process cartridge in the first embodiment is detached, and FIG. 3 is a perspective view of the image forming apparatus of the first embodiment.

As shown in FIGS. 1 and 2, the image forming apparatus 10 comprises an apparatus body (case) 12. In a lower portion of the apparatus body 12, a sheet supplying portion 64 (in FIG. 2, the hatched portion) which supplies a sheet (recording medium) P to an image forming portion (between process cartridges 28Y, 28M, 28C, 28K which will be described later, and a conveyor belt 26) is disposed.

The sheet supplying portion 64 is formed into a box-like shape, and configured by a detachable sheet supply cassette which is attachable and detachable in the directions of the arrow D. In the sheet supplying portion 64, a sheet tray 14 on which a bundle of sheets P is stacked is placed.

Above the tip end side (the right end side in FIG. 1) of the sheet tray 14, a feed roll 16 which pressingly contacts with the tip end side of the upper face of the sheet P and picks up the sheet P from the sheet tray 14 is placed.

A first transport path 22 is disposed which extends from a tip end portion of the sheet tray 14, which is gently bent, and which upward extends in the vertical direction in the front side (the right side in FIG. 1) of the apparatus.

Along the first transport path 22, plural (for example, two) conveyor roll pairs 24, and a strip-like conveyor belt 26 which electrostatically attracts the sheet P on which an image is to be formed, and conveys the sheet are sequentially arranged from the upstream side in the sheet conveying direction. The conveyor belt 26 is placed along the first transport path, thereby forming a part of one path surface of the first transport path 22.

The conveyor belt 26 is stretched by a tension roller 27 which is placed in the upper side, and a tension roller 29 which is placed in the lower side. When one of the tension rollers 27, 29 is rotated, the conveyor belt 26 is rotated in the direction of the arrow A.

In the upstream side of the conveyor belt 26 in the sheet conveying direction, a charging roll 31 which charges the surface of the conveyor belt 26, and which presses the sheet P electrostatically attracted to the conveyor belt 26 against the conveyor belt 26 is disposed in adjacent to the conveyor belt 26.

In the lateral side opposed to the conveyor belt 26 across the first transport path 22, the plural process cartridges (holding device for the image carrier) 28Y, 28M, 28C, 28K respectively corresponding to yellow, magenta, cyan, and black are arranged in parallel along the first transport path 22 in the vertical direction of the apparatus body 12.

Each of the process cartridges 28Y, 28M, 28C, 28K comprises a photoconductor drum (image carrier) 30 which is rotated in a predetermined direction (a counterclockwise direction in FIG. 1).

In the periphery of each photoconductor drum 30, a charging roller 32 which charges the surface of the photoconductor drum 30, an exposure device 34 which exposes the photoconductor 30 to form a latent image on the photoconductor drum 30, and a developing roller 36 which causes a toner of a corresponding color to adhere to the latent image formed on the photoconductor drum 30 are disposed sequentially from the upstream side in the rotation direction of the photoconductor drum 30.

In the inner circumferential side of the conveyor belt 26, transfer rolls 38 which transfer toner images formed on the respective photoconductor drums 30 to the sheet P at predetermined transferring stations are disposed at lateral positions of the photoconductor drums 30, respectively.

On the downstream side of the conveyor belt 26 in the sheet conveying direction, a fixing roll (fixing portion) 41 which is disposed in a fixing device 40 that fixes the transferred toner images (transferred images) to the sheet P, and, a conveyor roll pair 42 which transports the sheet P with clamping the sheet, a discharge roll pair 44 which discharges the sheet P to a discharge tray 20 are arranged. A visor 81 which blocks light from reaching the photoconductor drums 30 is disposed on a side face of the fixing device 40. The visor 81 will be described later in detail.

A second transport path 46 for inverting the sheet P in which an image is formed on one face, and then returning the sheet to the first transport path 22 is disposed with being opposed to the first transport path 22 across the conveyor belt 26.

In the second transport path 46, plural (for example, three) conveyor roll pairs 48 which downward transport the sheet P with clamping the sheet. When image formation is to be performed on the both faces, the sheet P in which an image is formed on one face is switched back to be guided to the second transport path 46 by the discharge roll pair 44, and downward conveyed by the plural conveyor roll pairs 48, with the result that the sheet is returned to the first transport path 22.

Next, the image forming operation of forming an image on the sheet P will be described with reference to FIG. 1.

In the image forming apparatus 10 of the first embodiment, in the case where an image formation is to be performed on one face of the sheet P, the sheet P picked up from the sheet tray 14 is upward transported by the plural conveyor roll pairs 24, and then sent to the conveyor belt 26. The sheet P sent to the conveyor belt 26 is pressed by the charging roll 31 against the conveyor belt 26, and electrostatically attracted to the charged conveyor belt 26 to be upward conveyed. Then, the sheet is sequentially transported to the predetermined transferring stations respectively corresponding to yellow, magenta, cyan, and black.

Onto the sheet P which is sent to the predetermined transferring stations, the toner images of the respective colors formed on the photoconductor drums 30 are transferred by the transfer rolls 38, thereby forming a full color image on the sheet P. Then, the sheet P is conveyed to the fixing device 40, the transferred toner image is fixed by the fixing device 40, and the sheet is discharged to the discharge tray 20 by the discharge roll pair 44.

In the case where an image formation is to be performed on the both faces of the sheet P, a toner image is fixed by the fixing device 40 and an image is formed on one face, and then the sheet is switched back by the discharge roll pair 44, so that the sheet P in which the image is formed on one face is inverted and sent to the second transport path 46. The sheet is returned from the second transport path 46 to the first transport path 22, and an image is formed on the other face in a similar manner as described above, with the result that images are formed on the both sides of the sheet P. As described above, the series of image forming operations are performed.

Next, the configuration for attaching and detaching the process cartridges 28Y, 28M, 28C, 28K will be described.

As shown in FIG. 2, the process cartridges 28Y, 28M, 28C, 28K can be attached and detached in lateral directions (directions of the arrow B). In each of the process cartridges 28Y, 28M, 28C, 28K, grasping portions 58 which are to be grasped during an attaching or detaching operation are disposed on both end portions in a direction perpendicular to the attaching and detaching directions or the lateral directions. The grasping portions 58 are molded integrally with a case (holding member) 28A which holds the photoconductor drum 30. In FIG. 1, the grasping portions 58 are omitted.

The process cartridges 28Y, 28M, 28C, 28K are guided to attaching positions by cartridge guides 70 which are formed on the apparatus body 12, respectively. The process cartridges 28Y, 28M, 28C, 28K which are guided to the attaching positions butt against end faces of the cartridge guides 70 at the position 71 so that the cartridge guides 70 is positioned.

A recess 72 which forms a space for grasping the grasping portion 58 is disposed in an inserting portion of each of the cartridge guides 70.

As shown in FIG. 2, an L-like cover member 50 is swingably supported on a lower portion of the sheet supplying portion 64 by a support shaft 51. When the cover member is swung and tilted from the side of the apparatus body 12 to the outside of the apparatus (in the direction of the arrow C in FIG. 2), the lateral or front sides of the process cartridges 28Y, 28M, 28C, 28K are opened. The cover member 50 allows the process cartridges 28Y, 28M, 28C, 28K to be attached and detached from the opened lateral or front sides of the process cartridges, i.e., the side of the cover member 50.

On the inner face side of the cover member 50, one path surface 46A of the second transport path 46 is formed, and one roller of each paired conveyor rolls 48 is disposed. A grasping portion 60 which is grasped when the cover member 50 is swung is disposed on the outer face side of the cover member 50.

As shown in FIG. 3, an opening 62 is disposed in a lower portion of the cover member 50 so that the cover member 50 is formed into a portal shape. The sheet supplying portion 64 (the hatched portion of FIG. 2) which is a sheet supply cassette can be attached and detached through the opening 62 in the directions of the arrow D.

A guide portion 66 in which the lowermost process cartridge 28Y can be placed, and which guides the placed process cartridge 28Y to the attaching position in the apparatus body 12 is formed on the upper face of the sheet supplying portion 64.

A conveyor belt unit 52 including the conveyor belt 26 is attached by a support shaft 53 to a portion of the cover member 50 which is above the opening 62, so as to be swung integrally with the cover member 50.

In the conveyor belt unit 52, the conveyor belt 26 is disposed on the side (the upper side in FIG. 2) opposed to the process cartridges 28Y, 28M, 28C, 28K, and the other path surface 46B of the second transport path 46, and the other roller of each paired conveyor rolls 48 are disposed on the side (the lower side in FIG. 2) of the conveyor belt unit 52 opposed to the cover member 50.

The other roller of each paired conveyor rolls 48, and the tension rollers 27, 29 which stretch the conveyor belt 26 are supported by a pair of side plates 68 of the conveyor belt unit 52 which are disposed on the both axial end sides of the rollers. The charging roll 31 is disposed integrally with the conveyor belt 26, so as to be swung integrally with the cover member 50.

The charging roll 31 and the conveyor belt 26 are configured so as to, when the cover member 50 is swung and the side of the cover member 50 is opened, be moved to a position lateral to the sheet supplying portion 64.

In the case where an image is formed on the sheet P, when the sheet P is jammed in the apparatus body 12, the grasping portion 60 of the cover member 50 is grasped and the cover member 50 is swung in a similar manner as the configuration for attaching and detaching the process cartridges 28Y, 28M, 28C, 28K, whereby the conveyor belt unit 52 is retracted and the side of the cover member 50 is opened, or the cover member 50 is opened. In this state, the sheet P is removed away.

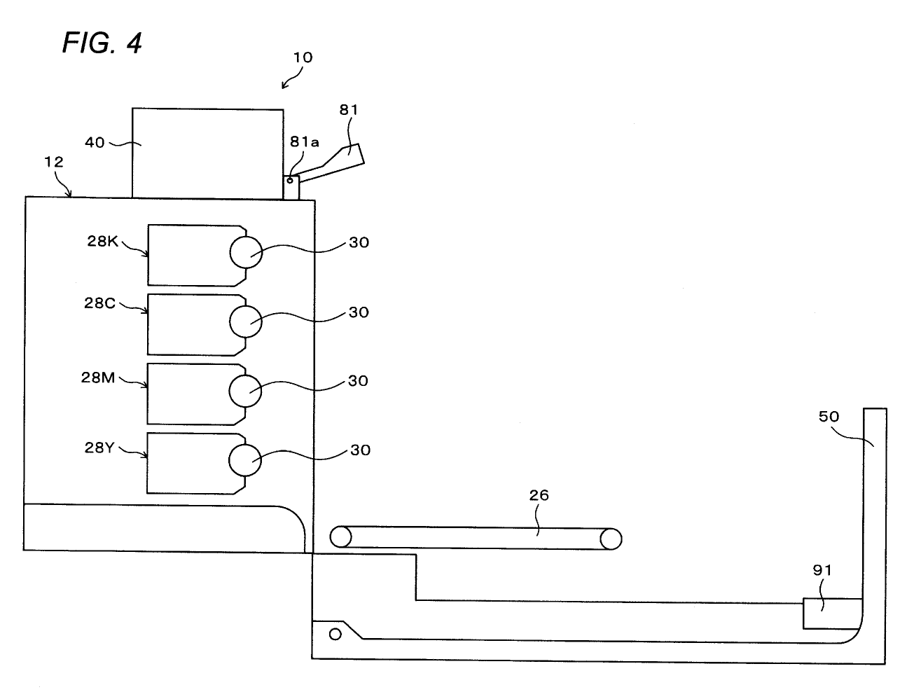

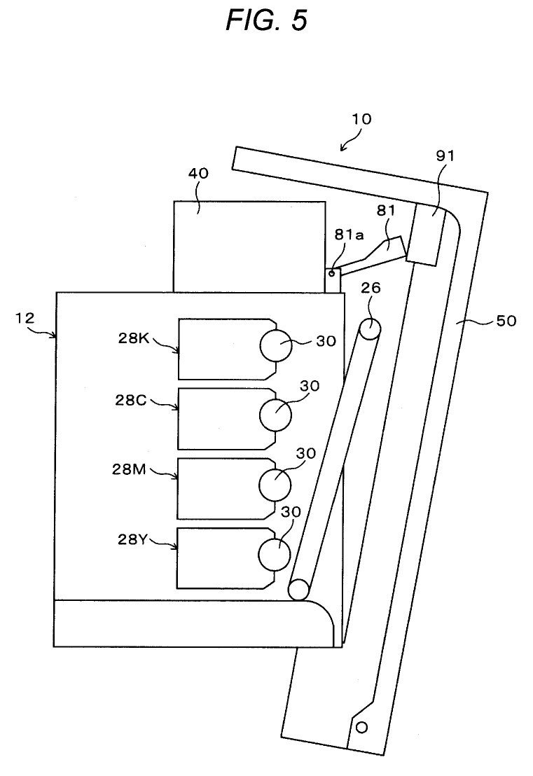

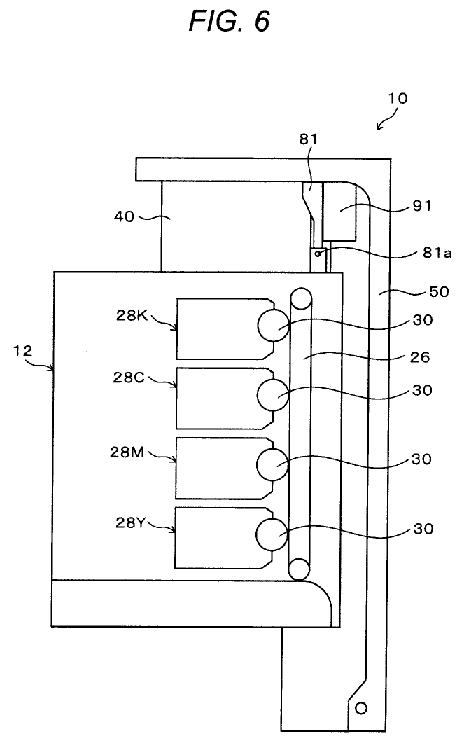

The configuration for operating the visor 81 will be described. FIG. 4 is a side view of a state where the cover member 50 is opened, FIG. 5 is a side view of a state where the cover member 50 is slightly opened, and FIG. 6 is a side view of a state where the cover member 50 is closed.

The visor (light blocking member) 81 is configured by a plate-like member, swingably supported by a support shaft 81a, and disposed on the side face of the fixing device 40 which is on the side of the cover member 50. In a state where the cover member 50 is opened, as shown in FIG. 4, the visor 81 is supported by the support shaft 81a to become a near horizontal state, thereby blocking light from reaching the photoconductor drums 30.

The length of the visor 81 in the direction to the side of the cover member 50 is 30 mm. Alternatively, the length of the visor may be changed on the basis of, for example, the positions of the fixing device 40, the photoconductor drum 30, and a light source. The mounting angle of the visor 81 is set so that the visor is approximately in the horizontal state. Alternatively, the mounting angle of the visor may have another value based on, for example, the positions of the fixing device 40, the photoconductor drum 30, and the light source.

A contacting member 91 is disposed on the inner face of the cover member 50. In a state where the cover member 50 is slightly opened, the contacting member is in contact with the visor 81. When the cover member 50 is gradually closed, the member raises the visor 81 from the horizontal state to the vertical state in accordance with the closing operation. In a state where the cover member 50 is closed, the visor 81 is fixed to maintain the vertical state.

Alternatively, the configuration for fixing the visor 81 may be formed in the following manner. A first connection portion is disposed in the fixing device 40, and a second connection portion is disposed in the visor 81. When the first and second connection portions are connected to each other in the state where the cover member 50 is closed, the visor 81 in the vertical state is connected to the fixing device, thereby fixing the visor 81. In the alternative, in order that, when the cover member 50 is gradually opened, the visor 81 is tilted from the vertical state to the horizontal state in accordance with the closing operation, a separating member for canceling the connection must be disposed on the upper face of the inner side of the cover member 50.

Next, the light blocking operation will be described.

When the cover member 50 is gradually opened, the visor 81 in the state where it is in contact with the contacting member 91 is gradually tilted by its own weight from the vertical state to the horizontal state. When the visor 81 becomes a near horizontal state, the visor 81 is separated from the contacting member 91, and the cover member 50 is opened. At this time, the visor 81 blocks light from reaching the photoconductor drums 30 disposed in the process cartridges 28Y, 28M, 28C, 28K.

When the cover member 50 is gradually closed, the visor 81 is contacted with the contacting member 91. When the cover member 50 is further gradually closed, the visor 81 is raised from the horizontal state to the vertical state in accordance with the closing operation. In the state where the cover member 50 is closed, the visor 81 is fixed while maintaining the vertical state.

TABLE 01
Grade change of light fatigue

| Color | | 0 min. | 5 min. | 10 min. | 30 min. |
|---|---|---|---|---|---|
| K | Without visor | 0 | 1.5 | 3.0 | 4.5 |
| | With visor | 0 | 1.0 | 2.5 | 4.5 |
| C | Without visor | 0 | 2.0 | 3.0 | 4.5 |
| | With visor | 0 | 1.5 | 2.0 | 3.5 |
| M | Without visor | 0 | 2.0 | 3.0 | 4.5 |
| | With visor | 0 | 1.5 | 2.0 | 3.5 |

Table 01 shows a grade change of the light fatigue, and obtained by checking the degrees of fatigues of the photoconductor drums 30 of the all colors except Y, in the state where the cover member 50 is opened. The grade of fatigues is specified by measuring the density difference between a portion of light fatigue and a portion of non-fatigue in an image pattern (halftone). The term of “With visor” means the state where the fixing device 40 comprises the visor, and the term of “Without visor” means the state where the fixing device 40 does not comprise the visor. When the value is small, the fatigue degree is low, and, when the value is large, the fatigue degree is high. As shown in Table 01, in the case where the visor 81 is provided, the fatigue degree is lower than the case where the visor is not provided.

### (2) Second Embodiment

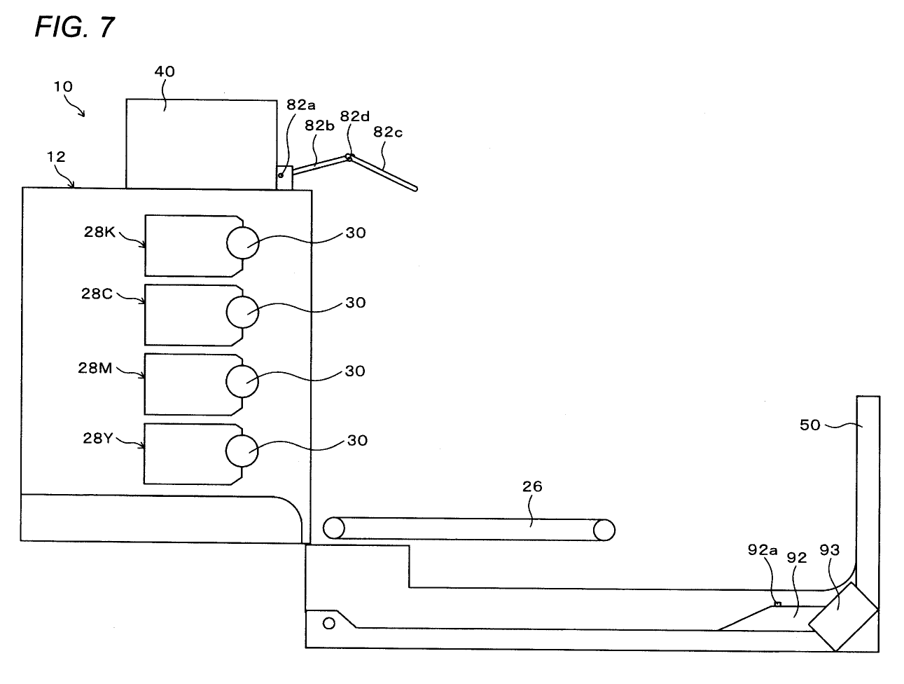

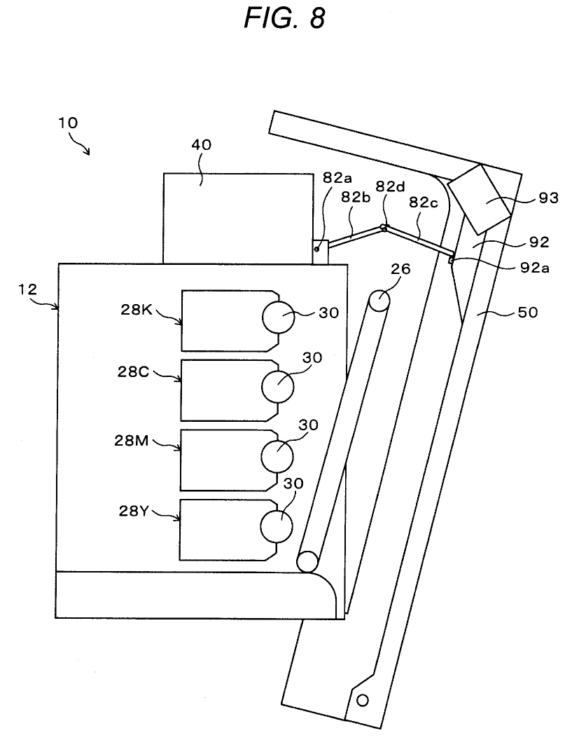

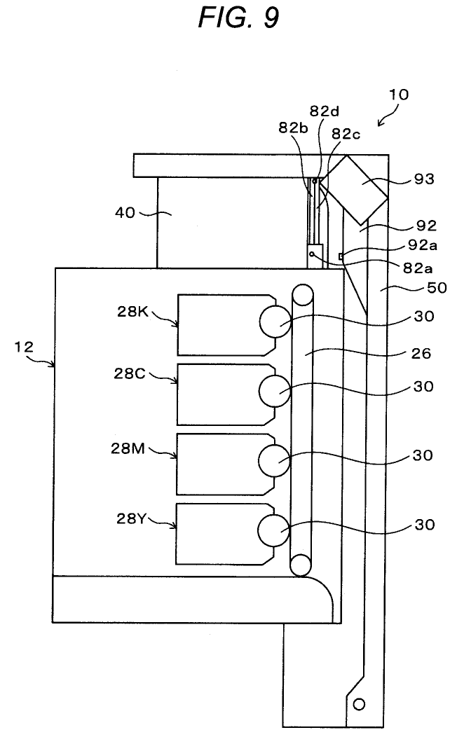

A second embodiment is a modification of a visor in the case where the visor is provided in the fixing device 40. FIG. 7 is a side view of a state where the cover member 50 is opened, FIG. 8 is a side view of a state where the cover member 50 is slightly opened, and FIG. 9 is a side view of a state where the cover member 50 is closed.

A visor 82 is configured by two plate-like members 82b, 82c, swingably supported by a support shaft 82a, and disposed on the side face of the fixing device 40 which is on the side of the cover member 50. The plate-like member 82b is swingably supported by a support shaft 82a, and the plate-like member 82c is supported swingably on the end of the plate-like member 82b opposite to the support shaft 82a by a support shaft 82d. In the state where the cover member 50 is opened, as shown in FIG. 7, the visor 82 is supported by the support shaft 82a to attain a developed state, thereby blocking light from reaching the photoconductor drums 30.

A contacting member 92 is disposed on the inner face of the cover member 50, and has a protrusion 92a. In the state where the cover member 50 is slightly opened, the contacting member is in contact with the visor 82. When the cover member 50 is gradually closed, the visor 82 is pressed and compressed from the developed state to an intermediate state in accordance with the closing operation. A fixing member 93 is disposed on the inner face of the cover member 50, and, in the state where the cover member 50 is closed, fixes the visor 82 to a folded state.

The second embodiment performs the light blocking operation in the following manner. When the cover member 50 is gradually opened, the visor 82 is gradually tilted by its own weight from the state where it is in contact with the fixing member 93, and then stretched to a state where the visor is in contact with the contacting member 92. When the visor 82 becomes the developed state, the visor 82 is separated from the contacting member 92, and the cover member 50 is opened. At this time, the visor 82 blocks light from reaching the photoconductor drums 30 disposed in the process cartridges 28Y, 28M, 28C, 28K.

When the cover member 50 is gradually closed, the visor 82 is contacted with the contacting member 92. When the cover member 50 is further gradually closed, the visor 82 is compressed from the developed state to the intermediate state in accordance with the closing operation.

In the state where the cover member 50 is closed, the visor 82 is fixed by the fixing member 93 while maintaining the folded state.

In the second embodiment, the visor 82 is configured by the two plate-like members 82b, 82c and foldable. Therefore, the length of the visor 82 in the direction to the side of the cover member 50 can be increased in the limited space as compared with the first embodiment. Therefore, the photoconductor drums 30 can be further shielded from light.

### (3) Third Embodiment

A third embodiment is a modification of a visor in the case where the visor is provided in the fixing device 40.

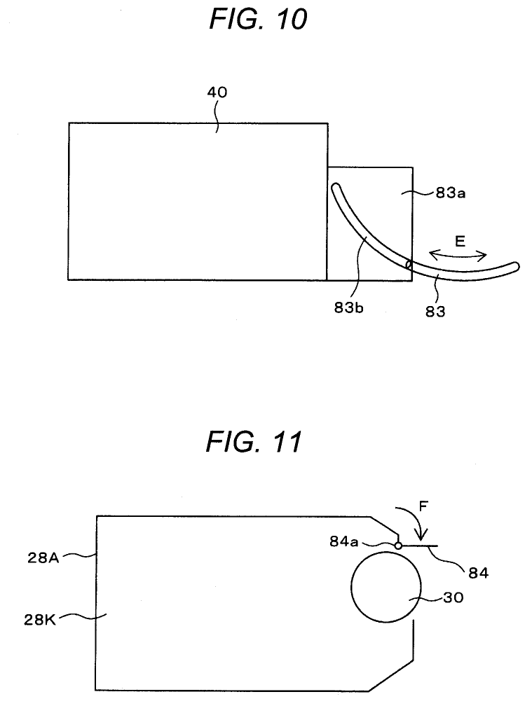

FIG. 10 is a view showing the third embodiment. A visor 83 is formed into an arcuate shape. An upper portion of the visor 83 is partly inserted into an opening 83b of a plate-like member 83a disposed in a side face of the fixing device 40 on the side of the cover member 50, and the visor is movable in the directions of the arrow E. In the state where the cover member 50 is opened, the upper portion of the visor 83 is moved to a portion below the opening 83b, thereby blocking light from reaching the photoconductor drums 30 disposed in the process cartridges 28Y, 28M, 28C, 28K.

### (4) Fourth Embodiment

A fourth embodiment is directed to a case where process cartridges for respective colors individually comprise visors. FIG. 11 is a side view of the process cartridge 28K in which a visor is disposed above the photoconductor drum 30. The visor 84 is configured by a plate-like member, swingably supported by a support shaft 84a, and disposed above the photoconductor drum 30 and on the case 28A on the side of the cover member 50.

The fourth embodiment performs the light blocking operation in the following manner. When the cover member 50 is opened, the visor 84 is moved by its own weight in the direction of the arrow F, i.e., in the direction along which it is separated from the case 28A. In the state where the cover member 50 is opened, the visor 84 is supported by the support shaft 84a to become a near horizontal state, thereby blocking light from reaching the photoconductor drum 30 disposed in the corresponding process cartridge 28Y, 28M, 28C, or 28K.

The length of the visor 84 in the direction to the side of the cover member 50 is 12 mm. Alternatively, the length may be changed on the basis of, for example, the positions of the photoconductor drum 30 and a light source. The mounting angle of the visor 84 is set so that the visor is downward tilted by 15 degrees with respect to the horizontal direction. Alternatively, the mounting angle may have another value based on, for example, the positions of the photoconductor drum 30 and the light source.

TABLE 02
Grade change of light fatigue

| Color | | 0 min. | 5 min. | 10 min. | 30 min. |
|---|---|---|---|---|---|
| K | Without visor | 0 | 1.5 | 3.0 | 4.5 |
| | With visor | 0 | 1.0 | 3.0 | 4.5 |
| C | Without visor | 0 | 2.0 | 3.0 | 4.5 |
| | With visor | 0 | 1.0 | 1.5 | 3.5 |
| M | Without visor | 0 | 2.0 | 3.0 | 4.5 |
| | With visor | 0 | 1.0 | 2.0 | 3.5 |

Table 02 shows a grade change of the light fatigue, and obtained by checking the degrees of fatigues of the photoconductor drums 30 of the all colors except Y, in the state where the cover member 50 is opened. The term of “With visor” means the state where the process cartridge comprises the visor, and the term of “Without visor” means the state where the process cartridge does not comprise the visor. When the value is small, the fatigue degree is low, and, when the value is large, the fatigue degree is high. As shown in Table 02, in the case where the visor 84 is provided, the fatigue degree is lower than the case where the visor is not provided.

### (5) Fifth Embodiment

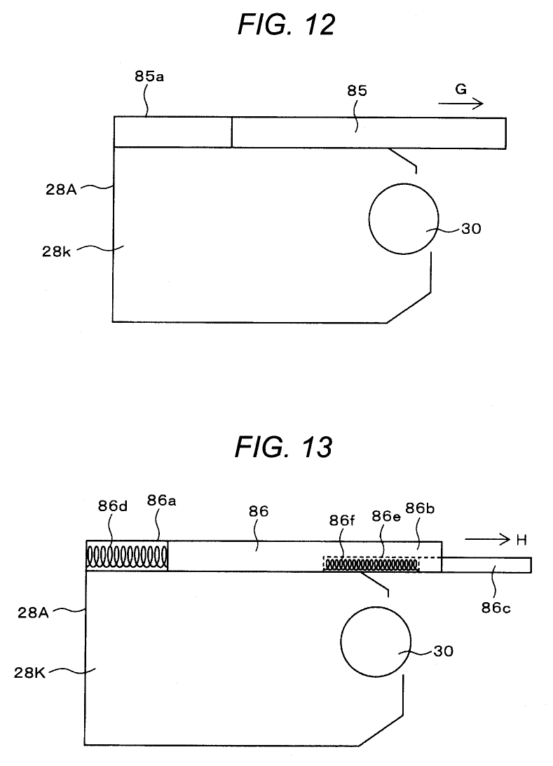

A fifth embodiment is directed to a case where process cartridges for respective colors individually comprise visors. FIG. 12 is a view showing the fifth embodiment. A visor 85 is configured by a plate-like member. When the cover member 50 is opened, the visor 85 is moved by the function of a cylinder 85a in the direction of the arrow G, i.e., in the direction along which the visor is separated from the case 28A. In the state where the cover member 50 is opened, the visor 85 becomes a near horizontal state, thereby blocking light from reaching the photoconductor drum 30 disposed in the corresponding process cartridge 28Y, 28M, 28C, or 28K. Alternatively, a tip end portion of the visor 85 is downward bent, so that the visor blocks more effectively light from reaching the photoconductor drum 30 than the case of a plate-like member.

### (6) Sixth Embodiment

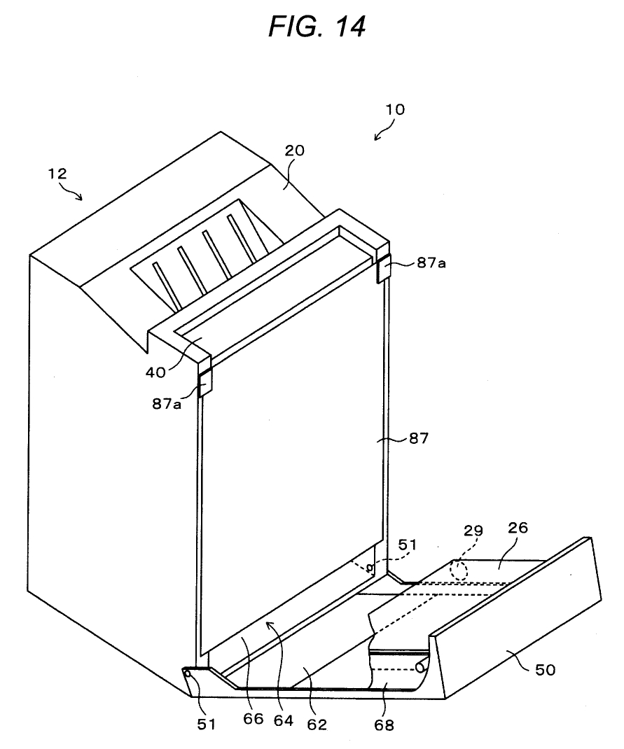

A sixth embodiment is directed to a case where process cartridges for respective colors individually comprise visors. FIG. 13 is a view showing the sixth embodiment. A visor 86 is configured by two plate-like members 86b, 86c and a spring 86f. A housing portion 86e is disposed in the plate-like member 86b, and the plate-like member 86c and the spring 86f are housed in the housing portion 86e.

When the cover member 50 is opened, the plate-like member 86b is moved by the function of a spring 86d in a case 86a in the direction of the arrow H, i.e., in the direction along which the plate-like member is separated from the case 28A. Furthermore, the plate-like member 86c is slid by the function of the spring 86f in the housing portion 86e to be moved in the direction along which the member is separated from the case 28A. In the state where the cover member 50 is opened, the visor 86 becomes a near horizontal state, thereby blocking light from reaching the photoconductor drum 30 disposed in the corresponding process cartridge 28Y, 28M, 28C, or 28K.

### (7) Seventh Embodiment

A seventh embodiment is directed to a case where a light-fatigue preventing cover is disposed on the opened face on the side of the cover member 50. FIG. 14 is a view showing the seventh embodiment. The light-fatigue preventing cover (light blocking member) 87 is configured by a planar member such as paper sheet, and comprises connecting members 87a. In the state where the cover member 50 is opened, the cover is connected to a side face of the apparatus body 12 on the side of the cover member 50 through the connecting members 87a.

The connecting members 87a are members which are disposed on the light-fatigue preventing cover 87, through which the light-fatigue preventing cover 87 is connected to the apparatus body 12, which are connected to portions where the apparatus body 12 and the cover member 50 are connected to each other in the state where the cover 50 is closed, and which prevent the cover member 50 from being closed.

The seventh embodiment performs the light blocking operation in the following manner. When the light-fatigue preventing cover 87 is attached to the side face of the apparatus body 12, the light-fatigue preventing cover 87 covers the photoconductor drum 30 in the state where the cover member 50 is opened, thereby blocking light from reaching the photoconductor drums 30 disposed in the corresponding process cartridge 28Y, 28M, 28C, or 28K. Then, the light-fatigue preventing cover 87 is detached, and the cover member 50 is closed.

The invention can be used in an image forming apparatus such as a printer, a facsimile apparatus, a copier, and a composite apparatus of such apparatuses.

What is claimed is:

1. An image forming apparatus comprising:
an image carrier;
a fixing device disposed above the image carrier and fixing a transferred image on a recording medium to the recording medium, the transferred image being transferred from the image carrier; and
a light blocking member disposed on the fixing device and blocking at least part of light reaching the image carrier.

2. The image forming apparatus according to claim 1, further comprising a cover member that constitutes an outer case of the image forming apparatus, that is openable and closable, and that covers the image carrier in a closed state,
the blocking member protruding toward the cover member in a state where the cover member is opened.

3. A fixing device comprising:
a fixing portion fixing a transferred image on a recording medium to the recording medium, the transferred image being transferred from an image carrier; and
a light blocking member blocking at least part of light reaching the image carrier.

4. The image forming apparatus according to claim 1, further comprising a cover member that constitutes an outer case of the image forming apparatus, that is openable and closable, and that covers the image carrier in a closed state,
the light blocking member blocking at least part of light reaching the image carrier in a state where the cover member is opened.

5. An image forming apparatus comprising:
an image carrier;
a light blocking member disposed above the image carrier; and
a cover member that constitutes an outer case of the image forming apparatus, that is openable and closable, and that covers the image carrier in a closed state,
the light blocking member protruding toward the cover member and blocking at least part of light reaching said image carrier in a state where the cover member is opened.

6. An image forming apparatus comprising:
an image carrier;
a light blocking member disposed above the image carrier; and
a holding member that holds the image carrier and the light blocking member,
a tip end of the light blocking member protruding in a direction away from the holding member,
the light blocking member blocking at least part of light reaching said image carrier.

7. A light blocking device comprising:
a holding member that holds an image carrier; and
a light blocking member disposed on the holding member, protruding in a direction away from the holding member, and blocking at least part of light reaching the image carrier.

8. A light blocking member detachable from an image forming apparatus comprising: a case; an image carrier in the case and a cover member that is openable and closable with respect to the case and that covers the image carrier, and,
the light blocking member is attached to the cover to block light from reaching the image carrier in a state where the cover member is opened.

9. The light blocking member according to claim 8, comprising a preventing member that prevents the cover member from being closed in a state where the light blocking member is attached to the case.

10. The image forming apparatus according to claim 2, further comprising a holding member that holds the image carrier in a state where a part of the image carrier is exposed, and that is detached or attached through an opening opened in the cover member while the part of the image carrier is exposed.

11. The image forming apparatus according to claim 5, further comprising a holding member that holds the image carrier in a state where a part of the image carrier is exposed, and that is detached or attached through an opening opened in the cover member while the part of the image carrier is exposed.

12. The image forming apparatus according to claim 6, further comprising a cover member that constitutes an outer case of the image forming apparatus and that is openable and closable,
the image carrier is exposed to an outside when the cover member is opened,
the holding member holding the image carrier in a state where a part of said image carrier is exposed, and being detached or attached through an opening opened in the cover member while the part of the image carrier is exposed.

13. The image forming apparatus according to claim 10, wherein when the cover member is opened, a tip end of the light blocking member is farther away from an exposed surface of the image carrier than a non-tip end side of the light blocking member.

14. The image forming apparatus according to claim 13, wherein a portion of the image carrier which is exposed from the holding member is exposed in a manner that the portion is visible from a vertically upper side.

15. The image forming apparatus according to claim 13, comprising a plurality of image carriers,
wherein when the cover member is opened, the image carriers are exposed to an outside with being arranged in a vertical direction of the image forming apparatus, and the light blocking member protrudes in a direction along which the cover member is opened, only above an uppermost image carrier among the plurality of image carriers.

16. The image forming apparatus according to claim 15, wherein the uppermost image carrier is an image carrier to carry a black toner.

17. The image forming apparatus according to claim 15, wherein a lowermost image carrier among the plurality of image carriers is an image carrier to carry a yellow toner.

18. The image forming apparatus according to claim 11, wherein when the cover member is opened, a tip end of the light blocking member is farther away from an exposed surface of the image carrier than a non-tip end side of the light blocking member.

19. The image forming apparatus according to claim 18, wherein a portion of the image carrier which is exposed from the holding member is exposed in a manner that the portion is visible from a vertically upper side.

20. The image forming apparatus according to claim 18, comprising a plurality of image carriers,
wherein when the cover member is opened, the image carriers are exposed to an outside with being arranged in a vertical direction of the image forming apparatus, and the light blocking member protrudes in a direction along which the cover member is opened, only above an uppermost image carrier among the plurality of image carriers.

21. The image forming apparatus according to claim 20, wherein the uppermost image carrier is an image carrier to carry a black toner.

22. The image forming apparatus according to claim 20, wherein a lowermost image carrier among the plurality of image carriers is an image carrier to carry a yellow toner.

23. The image forming apparatus according to claim 12, wherein when the cover member is opened, a tip end of the light blocking member is farther away from an exposed surface of the image carrier than a non-tip end side of the light blocking member.

24. The image forming apparatus according to claim 23, wherein a portion of the image carrier which is exposed from the holding member is exposed in a manner that the portion is visible from a vertically upper side.

25. The image forming apparatus according to claim 23, comprising a plurality of image carriers,
wherein when the cover member is opened, the image carriers are exposed to an outside with being arranged in a vertical direction of the image forming apparatus, and the light blocking member protrudes in a direction along which the cover member is opened, only above an uppermost image carrier among the plurality of image carriers.

26. The image forming apparatus according to claim 25, wherein the uppermost image carrier is an image carrier to carry a black toner.

27. The image forming apparatus according to claim 25, wherein a lowermost image carrier among the plurality of image carriers is an image carrier to carry a yellow toner.

28. A holding device for holding an image carrier, comprising:
an image carrier that is exposed to an outside of an image forming apparatus when a cover member that constitutes an outer case of the image forming apparatus and that is openable and closable is opened; and
a holding member that holds the image carrier in a state where a part of the image carrier is exposed, and is detached or attached through an opening opened in the cover member while the part of the image carrier is exposed, from below the light blocking member protruding toward the cover member in conjunction with opening of the cover member.
